(19) United States
(12) Patent Application Publication
(10) Pub. No.: US 2013/0270193 A1
(43) Pub. Date: Oct. 17, 2013

(54) METHOD FOR WATER SANITISATION

(71) Applicant: Ross Leslie Palmer, Mt Gravatt (AU)

(72) Inventor: Ross Leslie Palmer, Mt Gravatt (AU)

(73) Assignee: POOLRITE RESEARCH PTY LTD, Queensland (AU)

(21) Appl. No.: 13/880,479

(22) PCT Filed: Oct. 20, 2011
(86) PCT No.: PCT/AU2011/001334

§ 371 Date: Jul. 8, 2013

(30) Foreign Application Priority Data
Oct. 20, 2010 (AU) 2010904683

(51) Int. Cl. C02F 1/467

(52) U.S. Cl. CPC C02F 1/4674
USPC 210/747.1; 210/167.11

(57) ABSTRACT

A method of sanitising swimming pool water including forming a matrix comprising one or more insoluble metal salts adjacent an at least one anode and/or an at least one cathode of an electrolytic cell. When water from the pool is passed through the active electrolytic cell the presence of the matrix of insoluble metal salts enhances the generation of active oxygen species which results in sanitisation of the swimming pool water.

### FIELD OF THE INVENTION

The present invention relates to the field of water treatment. More particularly, this invention relates to a method and system for electrochemical disinfection of water.

### BACKGROUND OF THE INVENTION

Swimming pools (also referred to herein as “pools”) are popular for exercising and relaxing in, but if they are to be maintained so as to provide a safe and healthy swimming environment then the pool water must undergo regular treatment to remain clear, clean and free from pathogens. Pathogens are of particular concern as their presence can result in bathers being exposed to serious health risks. Pathogens such as Escherichia Coli, Giardia Lamblia and Cryptosporidium are commonly found in pools, particularly commercial pools, and can cause a range of symptoms from fever and diarrhoea to kidney damage and, potentially, even death. The treatment of pool water typically involves maintaining a consistent level of chlorine.

Chlorine is a widely used disinfectant which is generally effective in controlling the levels of harmful organisms such as bacteria, viruses, algae and fungi. Chlorine can be introduced into the pool by regular addition of commercially available chlorine sources such as granular chlorine, chlorine tablets or liquid chlorine. This may involve handling dangerous chemicals and can result in large and undesirable fluctuations in the levels achieved in the pool.

Electrolytic, or saltwater, chlorinators are a preferable solution. This requires the addition of salt (sodium chloride) to the pool and so does not necessitate handling dangerous chemicals. The electrolysis process is achieved by passing the salt water solution through an electrolytic cell which converts sodium chloride in the water into chlorine gas which, when dissolved in water becomes sodium hypochlorite (liquid chlorine). The pool owner must monitor the level of salt within the pool and ensure that it is maintained at an appropriate level to kill pathogens. Although generally effective many users find the chlorine in the pool irritates their eyes or dries out and damages their hair and skin.

More pool owners are now looking to technologies which employ ‘electrochemical disinfection’ to keep their pool pathogen free. Electrochemical disinfection can be defined as the eradication of microorganisms by means of an electric current passed through the water under treatment by employing suitable electrodes. The main difference between this and the use of electrolytic chlorinators is that no additional chemicals are added to the water being treated during electrochemical disinfection. The electric current used leads to the production of disinfecting active oxygen species from the water itself, such as ozone, peroxide and hydroxyl radicals, which may be many times more effective than chlorine in destroying pathogens. This method thus greatly lowers the use of potentially hazardous chemicals.

Current electrochemical disinfection systems are often prohibitively expensive due to the requirement for specialised electrode materials such as boron-doped diamond electrodes or silicon/titanium electrodes doped with diamond. This has limited the uptake of these systems even though their effectiveness and environmentally friendly credentials are well recognised. A further concern is in maintaining a sufficient residual sanitiser level in the pool when the electrochemical disinfection system is not actively running since most of the active oxygen species are relatively short lived and so do not accumulate in the pool.

OBJECT OF THE INVENTION

It is an object of the invention to overcome or alleviate one or more of the above disadvantages or provide the consumer with a useful or commercial choice.

### SUMMARY OF THE INVENTION

In one form, which is not necessarily the only or the broadest form, the invention resides in a method of sanitising a body of water including the steps of:
(a) providing an electrolytic cell having a flow inlet to allow water from the body of water to enter the cell, and a flow path having at least one anode and at least one cathode located within the flow path and a flow outlet to allow water exiting the cell to be returned to the body of water;
(b) forming a matrix comprising one or more insoluble metal salts adjacent a substantial portion of the at least one anode and/or at least one cathode;
(c) placing the electrolytic cell, comprising the matrix within a flow of water from the body of water; and
(d) passing the water, via the flow inlet, through the flow path to thereby generate active oxygen species and sanitise the body of water.

Suitably, the body of water being sanitised is a swimming pool.

The one or more insoluble metal salts may comprise a metal carbonate and/or hydroxide and/or oxide.

Preferably, the one or more insoluble metal salts may comprise calcium carbonate and/or magnesium carbonate.

Suitably, the matrix is in contact with the at least one anode and/or at least one cathode.

In a further form the invention resides in a system for sanitising water comprising:
(a) a flow inlet;
(b) a first electrolytic cell having a first flow path adapted to receive water from the flow inlet and at least one anode and at least one cathode located within the first flow path and a first flow path outlet; and
(c) a second electrolytic cell having a second flow path adapted to receive water from the flow inlet or from the first flow path outlet and at least one anode and at least one cathode located within the second flow path;

wherein the at least one anode and/or at least one cathode or one of the first or the second electrolytic cells has a matrix comprising one or more insoluble metal salts formed adjacent a surface thereof.

The second electrolytic cell may be connected in series with the first electrolytic cell such that the second flow path is in fluid communication with the first flow path and receives water from the first flow path outlet.

If required, a switch may be provided to switch power between the first and second electrolytic cells.

The one or more insoluble metal salts may comprise a metal carbonate and/or hydroxide and/or oxide.

Preferably, the one or more insoluble metal salts may comprise calcium carbonate and/or magnesium carbonate.

In one embodiment, the matrix is formed by applying an effective amount of an insoluble metal salt paste to the at least anode and/or at least one cathode.

Suitably, the matrix is in contact with the at least one anode and/or at least one cathode.

One of the first or second electrolytic cells may operate as an electrolytic chlorinator cell predominantly producing chlorine as a sanitiser.

The other of the first or second electrolytic cells may operate as a sanitiser predominantly producing active oxygen species.

Suitably, the active oxygen species may comprise hydroxyl radicals, oxygen radicals, ozone or peroxide.

Preferably; the system further comprises an analysing means to monitor the level of chlorine in the water.

Suitably, the analysing means actuates the switch to divert the power to the first electrolytic cell when chlorine levels are low and to the second electrolytic cell when chlorine levels are optimal.

In yet a further form the invention resides in a method of sanitising water including the steps of:
(a) providing a water flow inlet;
(b) providing a first electrolytic cell having a first flow path adapted to receive water from the flow inlet and at least one anode and at least one cathode located within the first flow path and a first flow path outlet;
(c) providing a second electrolytic cell having a second flow path adapted to receive water from the flow inlet or the first flow path outlet and at least one anode and at least one cathode located within the second flow path;
(d) forming a matrix comprising one or more insoluble metal salts adjacent the at least one anode and/or at least one cathode of the second electrolytic cell; and
(e) passing a flow of water through the water flow inlet;

whereby, activation of the first electrolytic cell causes the production of active chlorine and activation of the second electrolytic cell causes the production of active oxygen species.

The second electrolytic cell may be connected in series with the first electrolytic cell such that the second flow path is in fluid communication with the first flow path.

If required, a switch may be provided to switch power between the first and second electrolytic cells.

The one or more insoluble metal salts may comprise a metal carbonate and/or hydroxide and/or oxide.

Preferably, the one or more insoluble metal salts may comprise calcium carbonate and/or magnesium carbonate.

Suitably, the matrix is in contact with the at least one anode and/or at least one cathode.

Preferably, the water being sanitised is swimming pool water.

The at least one anode and at least one cathode of the first electrolytic cell may be substantially free of insoluble metal salts.

Suitably, the active oxygen species may comprise hydroxyl, radicals, oxygen radicals, ozone or peroxide.

Preferably, the method further includes the step of monitoring the level of chlorine in the water.

Suitably, the method further includes the step of switching the power to the first electrolytic cell when chlorine levels are low and to the second electrolytic cell when chlorine levels are optimal.

Throughout this specification, unless the context requires otherwise, the words “comprise”, “comprises” and “comprising” will be understood to imply the inclusion of a stated integer or group of integers but not the exclusion of any other integer or group of integers.

### BRIEF DESCRIPTION OF THE FIGURES

In order that the invention may be readily understood and put into practical effect, preferred embodiments will now be described by way of example with reference to the accompanying figures wherein like reference numerals refer to like parts and wherein:

FIG. 1 is a perspective view of one embodiment of an electrode assembly with a matrix formed thereon;

FIG. 2 is a perspective view of a further embodiment of an electrode assembly with a matrix formed thereon;

FIG. 3 is a front view of an electrolytic cell suitable for use in the method of the invention;

FIG. 4 is a perspective view of the electrolytic cell shown in FIG. 3;

FIG. 5 shows an electrolytic cell with gas bubbler according to one embodiment of the invention; and

FIG. 6 shows a schematic of bubble flow through the system of FIG. 5.

### DETAILED DESCRIPTION OF THE INVENTION

As used herein, the expression “swimming pool” is also intended to embrace the analogous use of spa baths, hot tubs and the like which are operated in a substantially identical manner to swimming pools.

The terms “sanitise”, “sanitiser” and “sanitising” as used herein encompass the killing, controlling or rendering harmless to humans of the population of one or more pathogens and/or the reduction of the levels of chemical species such as urea and like bather residues.

Although the following discussion focuses on the use of the inventive method and system to sanitise pool water it will be understood that it is not so limited. The present invention may be applied mutatis mutandis to any body of water requiring sanitisation such as, but not limited to, water within cooling towers, drinking water supplies and hot water recirculating systems.

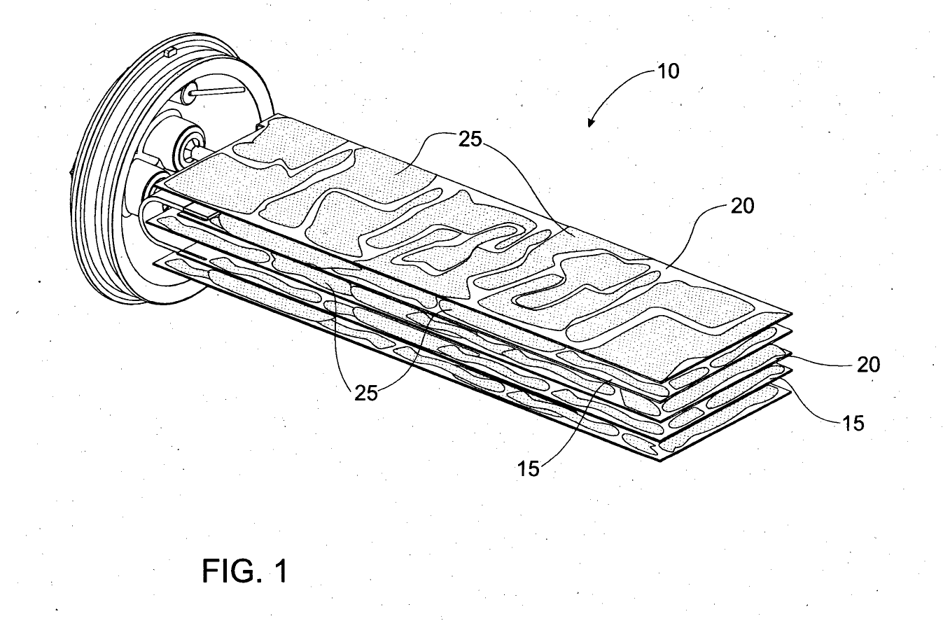

Referring now to FIG. 1, which is a perspective view of one embodiment of an electrode assembly with a matrix formed thereon, electrode assembly 10 comprises a series of anodes 15 and cathodes 20 which are connected to standard respective anode and cathode terminals. In the embodiment shown a discontinuous matrix 25 has been formed upon the surface of both the anodes 15 and cathodes 20. Matrix 25 may, however, take the form of a continuous sheet adhered upon the available surfaces of anode 15 and/or cathode 20 if matrix 25 is porous enough to allow sufficient water flow to contact anodes 15 and cathodes 20.

Matrix 25 may cover the majority of the available surfaces of anode 15 and/or cathode 20. Matrix 25 may be distributed equally upon anodes 15 and cathodes 20 although, in practice, the majority of matrix 25 will likely be found on cathodes 20 due to the electrochemical reaction occurring there resulting in an alkaline pH in the vicinity of cathodes 20 thereby encouraging salt deposition. Portions of matrix 25 around anode 15 may be adjacent anode 15 rather than in direct contact therewith. This is due to the electrochemical reaction at anode 15 creating an acidic environment which has a tendency to dissolve the salts.

Matrix 25 may comprise one or more insoluble metal salts such as, for example, metal carbonates and/or hydroxides and/or oxides. In one general embodiment matrix 25 will comprise a metal carbonate and/or hydroxide and/or oxide selected from the group consisting of magnesium carbonate, calcium carbonate, beryllium carbonate, magnesium hydroxide, calcium hydroxide, beryllium hydroxide, magnesium oxide, calcium oxide and beryllium oxide.

Preferably, matrix 25 comprises calcium carbonate and/or magnesium carbonate. In one embodiment matrix 25 is substantially formed from magnesium carbonate and calcium carbonate.

The inventors have unexpectedly discovered that a coating or matrix 25 of magnesium carbonate and/or calcium carbonate formed on anodes 15 and/or cathodes 20 in a swimming pool electrolytic cell produces a very significant amount of active oxygen species during use. The active oxygen species may include a range of short and longer lived reactive species including hydroxyl radicals, ozone, oxygen radicals and peroxide.

Typically, pool owners monitor the electrodes of their electrolytic cell for the build up of calcareous deposits which will predominantly form on the cathode. When the build up reaches a significant level then the electrolytic cell is generally disconnected from the rest of the system and the electrode plates are immersed in an acid, such as muriatic acid, to remove the deposited salts. It has not previously been recognised that this build up of metal salts may, when present in sufficient quantities, provide certain advantages in use due to the highly efficient sanitising power of the active oxygen species produced.

Matrix 25 may be formed on at least one anode 15 and/or at least one cathode 20 by a manufacturer by actually using the electrode assembly 10 in an artificially created water flow whereby the concentrations of salts such as sodium, magnesium and potassium halide and/or sulphate and/or hydroxide are optimised for matrix 25 growth. That is, the matrix 25 is preferably formed on the at least one anode 15 and/or the at least one cathode 20 in an environment outside of or remote from the intended location of use. In one embodiment, the matrix is formed by applying an effective amount of an insoluble metal salt paste to the at least anode and/or at least one cathode. Advantageously, anode 15 and cathode 20 may be made from standard electrode plate materials such as titanium and matrix 25 grown thereon. Preferably, anode 15 and cathode 20 will be constructed from or coated with materials resistant to damage from active oxygen species. This is in contrast to known electrochemical disinfection systems using expensive specialised plates including those doped with diamond dust or coated with certain rare earth metals to produce the required levels of active oxygen species.

Alternatively, a solution or mixture of the desired salts, such as magnesium carbonate and calcium carbonate, which make up matrix 25 can be formulated and simply applied to at least one anode 15 and/or at least one cathode 20 of an electrolytic cell 10. Upon drying, the electrolytic cell 10 thus comprises a pre-formed matrix 25 and is immediately ready for use in a commercial or residential pool setting.

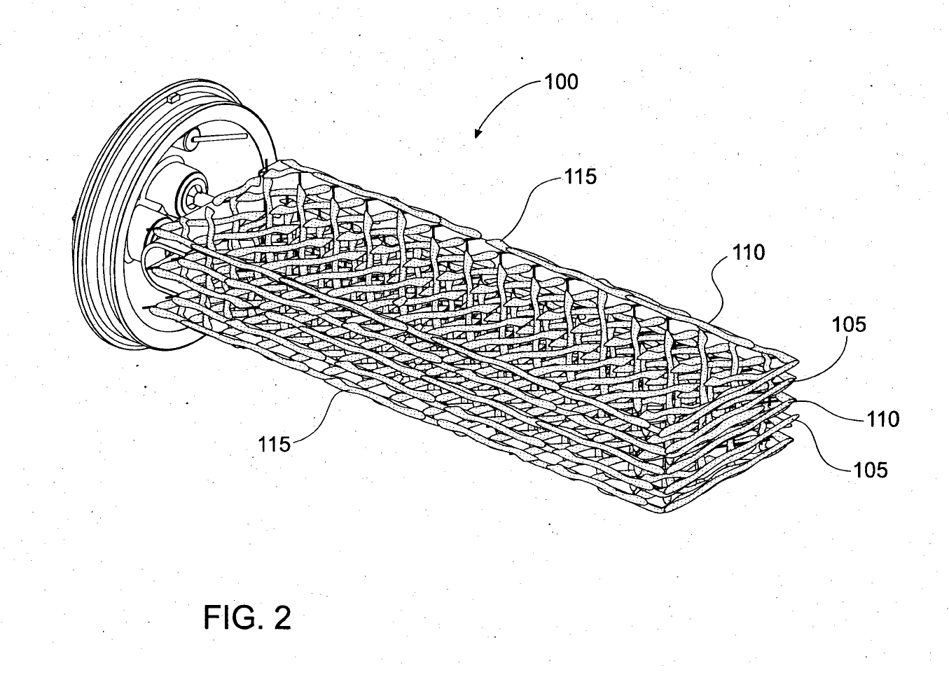

FIG. 2 is a perspective view of a further embodiment of an electrode assembly 100 comprising anodes 105 and cathodes 110 with a matrix 115 formed thereon. In this embodiment the anodes 105 and/or cathodes 110 are of a wire mesh design, but may be porous or perforated plates, and may be constructed from titanium, coated titanium or a hastelloy alloy. This design provides an increased surface area for formation and exposure of matrix 115 thus maximising the production of active oxygen species.

Matrix 115 is seen in FIG. 2 to cover most of the surface of anodes 105 and cathodes 110. The desired extent of this coverage will represent a balance between maximising the amount of matrix 115 to increase the active oxygen producing ability of electrode assembly 100 and still allowing sufficient water to contact the surface of anodes 105 and cathodes 110. If the surface of anodes 105 and cathodes 110 are entirely covered in matrix 115 then, depending on the porosity of matrix 115, water may not be able to penetrate and production of active oxygen species will halt.

The porosity of matrix 115 will depend on its exact composition and so may be tuned as desired. Generally, a higher concentration of magnesium carbonate relative to calcium carbonate will produce a matrix 115 which is softer and allows water to penetrate more readily. The actual active oxygen species and, more generally, sanitising species produced by electrode assemblies 10 and 100 will depend upon the chemical content of the water being treated. For example, if the water contains significant sodium chloride then hypochlorous acid will be produced in the normal manner to provide a residual sanitiser for the swimming pool in addition to the active oxygen species being produced. In water with low or no chloride content the active oxygen species, including hydroxyl radicals and ozone, take over all of the sanitising work.

In one particular embodiment of the present invention two electrochemical cells are connected in series and one of the cells will have an electrode assembly with a metal carbonate and/or hydroxide and/or oxide matrix formed on at least a portion of the anode and/or cathode surface while the other. cell will not. The pool water will run through both cells but, generally, only one of the cells will be active at any one time. This embodiment provides distinct advantages in operation. For example, when it is desired to raise the active chlorine level in the pool then the cell which does not have the pre-formed matrix of metal carbonate and/or hydroxide and/or oxide would be active and would operate as a standard electrolytic chlorinator cell to split the chloride salts in the water. When the chlorine level has reached an optimal point then this cell can be switched off and the other cell containing the electrode assembly having the pre-formed matrix of metal carbonate and/or hydroxide and/or oxide can be switched on. This provides a supply of active oxygen species such as hydroxyl radicals and ozone which are stronger sanitisers than chlorine. These species can be useful in destroying or rendering harmless to humans any surviving potentially harmful pathogens such as Escherichia Coli, Giardia Lamblia and Cryptosporidium which may not be effectively rendered harmless or prevented from reproducing by the presence of chlorine alone in the pool.

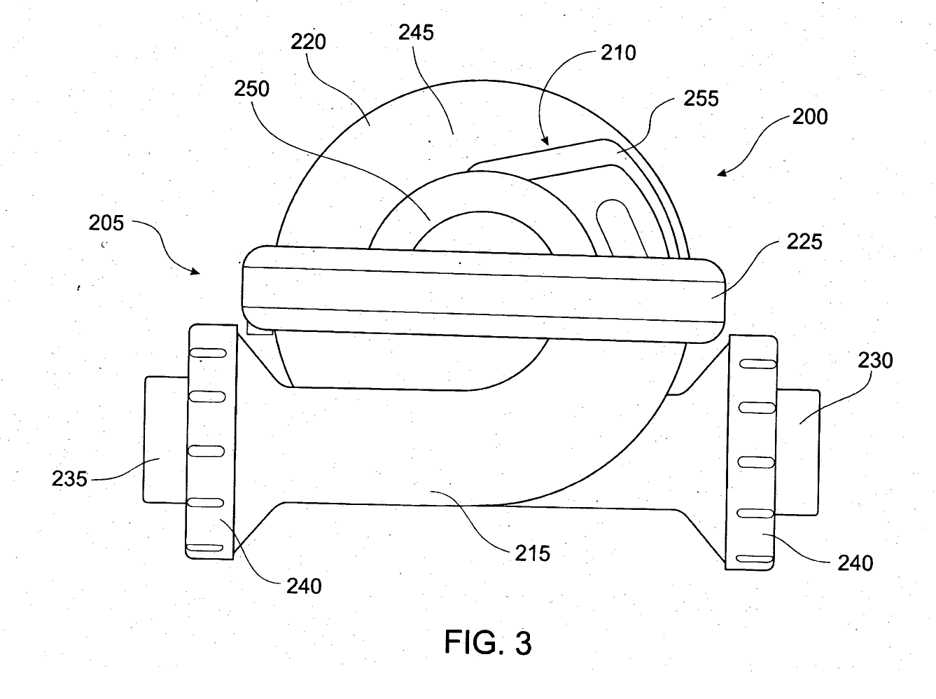

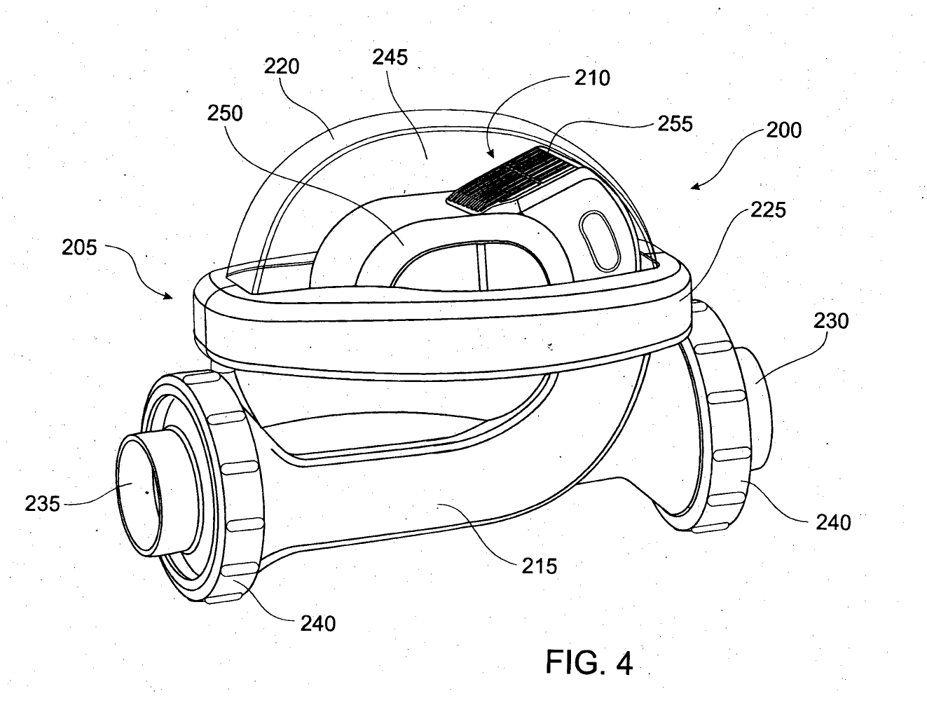

FIGS. 3 and 4 show an electrolytic cell 200, in front and perspective view, respectively, particularly suitable for use as the standard non-matrix coated electrolytic chlorinator cell in the method of the invention when in combination with a more standard design employing matrix coated electrode plates. The electrolytic cell shown in FIG. 3 is described in the applicant's earlier filed PCT application, PCT/AU2010/000931, the contents of which are hereby incorporated in their entirety. It will be appreciated that the present method may be used with any suitable design of electrolytic cell as the standard (non-matrix coated) electrolytic chlorinator cell, however, the design shown in FIG. 3 provides certain advantages in operation. Further, any suitable design of electrolytic cell may be employed as the active oxygen generating cell so long as a suitable metal carbonate and/or hydroxide and/or oxide can be formed upon one or more of the electrode plates.

Briefly, electrolytic cell 200 includes a housing 205 and an electrode cartridge 210. The housing 205 is made up of a base 215, a cap 220 and two side covers 225. The cap 220 is removably attached to the base 215.

An inlet 230 is located at one end of base 215 with an outlet 235 located on the other end of base 215. Both inlet 230 and outlet 235 have associated pipe connectors 240 to enable housing 205 to be connected to associated pipes (not shown). The inlet 230 and outlet 235 are in alignment with each other. However, it will be appreciated that this may not necessarily be the case depending on the design of the pool chlorination system.

The spiral shape of channel 245 allows inlet 230 and outlet 235 to be in alignment. This increases hydraulic efficiency as the water does not need to pass through any 90 degree turns. Instead, the water moves from inlet 230 to outlet 235 via the spiral shaped channel 245 which has increased hydraulic efficiency compared to traditional electrolytic cells.

In use, water flows into channel 245 through inlet 230 and then passes through base 215 and into cap 220 passing around an arcuate edge of a removable central member 250. Water then passes through apertures formed in the top portion of an outer bracket 255 which reduces the area that the water can flow through. Accordingly, the velocity of the water is increased as it passes through the apertures in outer bracket 255, passes past the electrodes and out through apertures formed in the bottom portion of outer bracket 255 (not shown). This increase in velocity of the water may reduce the build up of calcareous deposits on the electrodes which, in the one of the electrolytic cells in series devoted purely to electrolytic chlorination, is desirable to reduce maintenance. The water then passes out of outlet 235.

The electrolytic cell which is to contain the anode and/or cathode with a metal carbonate and/or hydroxide and/or oxide coating formed thereon may be of similar design to that shown in FIGS. 3 and 4 only if the matrix is pre-formed on the electrode(s) before introduction into cell 200 since the design of cell 200, as described above, is such that build up of the desired deposits while in use would be unlikely or at least undesirably slow. A more standard prior art design which would be well known to the skilled addressee would be more suitable, for example, a non-reversing electrolytic cell which does not employ a velocity cleaning effect such as that described above.

The two electrolytic cells, one with and one without matrix 25, may be set up in parallel or in series with one another. For example, in series the water flow inlet may introduce water into the flow path of the first electrolytic cell and after passing through the first electrolytic cell, which may or may not be active, the water then enters the flow path of the second electrolytic cell which may or may not be active. Alternatively, the water flow inlet may split into two channels one of which introduces water into the flow path of the first electrolytic cell and one of which introduces water into the flow path of the second electrolytic cell. A diverting mechanism may be provided such that water can be preferentially directed into one electrolytic cell or the other or it may be allowed to pass through both simultaneously in two separate streams.

A switch may be provided to switch power between the first or second electrolytic cell or both may be activated simultaneously.

When connected in series, the electrolytic cell which is to contain the anode and/or cathode with a metal carbonate and/or hydroxide and/or oxide coating formed thereon may be before or after the standard chlorinator cell i.e. when the two cells are in series it is contemplated that the water may first pass through either the chlorinator cell or the active oxygen species producing cell.

In one general embodiment the electrolytic cell containing the anode and/or cathode with the matrix formed thereon may have a stream of oxygen introduced to the water flow passing there through to increase the generation of active oxygen species including hydroxyl species. Although not wishing to be bound by any particular theory it is believed that an excess of available oxygen leads to increased production of hydrogen peroxide and hydroxyl species at the cathode.

The oxygen may be introduced to the cell itself or may be introduced into the water flow pipe just above the point where it opens up into the cell. The oxygen may be industrial grade or high purity oxygen which can be supplied from a suitable pressurized cylinder or the like.

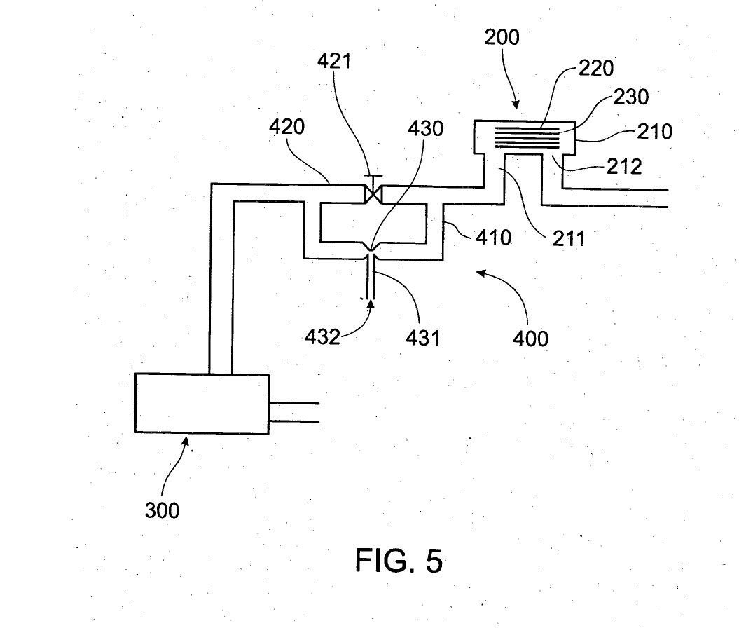

In one embodiment the oxygen or oxygen containing gas is introduced as shown in FIG. 5. The system includes an electrolytic cell 200, a pump 300 and a bubbler 400. The electrolytic cell 200 has a housing 210 with an inlet 211 and an outlet 212. A series of anodes 220 and cathodes 230 are located within the housing 210.

The pump 300 is in fluid communication with the electrolytic cell 200 and pumps pool water from a source to the electrolytic cell 200. The inlet 211 of the housing 210 is fluidly connected to the pump 300 to allow aqueous solution to be pumped into the housing 210 which is subsequently expelled out of the outlet 212. The bubbler 400 introduces a plurality of bubbles into the aqueous solution. The bubbler 400 comprises a bypass loop 410 placed in fluid connection with a pipe 420 connecting the pump 300 to the electrolytic cell 200. The bypass loop 410 is suitably formed by a pipe. A constricted section 430 of pipe having a reduced internal diameter forms part of the bypass loop 410.

A bubble inlet 431 is located on the constricted section 430 and is suitably connected to a vent 432 to the atmosphere. The vent 432 may simply be a hole, or a length of tubing. The bypass loop 410 may also include one or more valves (not shown) to shut off the flow of aqueous solution to the bypass loop 410. Preferably, a pipe valve 421 is included in the section of pipe 420 encompassed by the bypass loop 410.

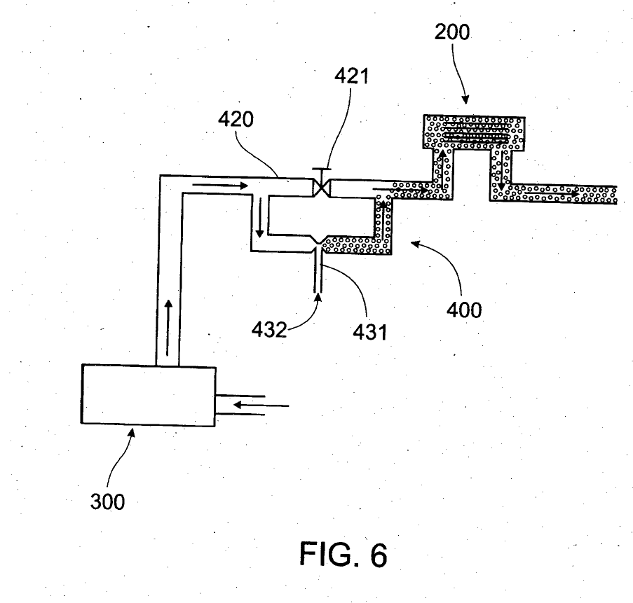

In use, gas is periodically allowed to enter the aqueous solution through the bubble inlet 431 whilst the aqueous solution is flowing to the electrolytic cell 200. A schematic showing water flow arrows and bubble flow , through the embodiment of the apparatus of FIG. 5 is shown in FIG. 6. The embodiment of the bubbler 400, where the bubble inlet 431 is a vent 432 to the atmosphere, makes use of the venturi effect, wherein a reduction in fluid pressure results when a fluid passes through a constriction. If a hole is made in the constriction, the lower fluid pressure within the constriction will suck air in through the hole, and a stream of bubbles is created within the fluid. Movement of the pipe valve 421 alters the proportion of aqueous solution which passes through the bypass loop 410 and thus alters the quantity of bubbles entering the aqueous solution from the bubble inlet 431.

In one alternative embodiment of the apparatus shown in FIG. 5, a vent valve may also be included to regulate the amount of air entering the vent 432. Further, if required, a length of tubing may be fluidly connected to the bubble inlet 431 of the bypass loop 410. The bubble inlet 431 may be directly located on the bypass loop 410 which, in this embodiment, suitably does not include a constricted section 430. The length of tubing is connected to a chamber which may contain compressed gas (e.g. compressed O₂ gas) to be introduced through the bubble inlet 431 into the aqueous solution passing through the bypass loop 410, thus creating a plurality of bubbles in the aqueous solution. Preferably, a chamber valve controls entry of gas from the chamber through the bubble inlet 431.

In a further embodiment of the apparatus shown in FIG. 5, the constricted section 430 of piping is located prior to the pump 300. The bubble inlet 431 is included within the constricted section 430 of piping, and a solenoid valve may be included to control air entry through the bubble inlet 431. The solenoid valve is preferably a ‘normally closed’ solenoid valve which allows air to be drawn from the atmosphere into the constricted section 430 of piping whilst the pump 300 is running. When the pump 300 is switched off, the solenoid valve closes, thus preventing aqueous solution within the piping from leaking out through the bubble inlet 431. Other types of valves may also be used to control the flow of air through the bubble inlet 431. The rate of introduction of bubbles and the turbulence should be controlled so as not to displace or break up the insoluble metal salt matrix responsible for forming the active oxygen species.

Although the present method may be useful for sanitizing any form of water from ultrapure to brine/seawater in one preferred form it is employed with swimming pool water comprising one or more of a soluble magnesium, potassium or sodium halide salt or any other salt as described in the applicants previously filed PCT application published as WO/2008/000029 and incorporated herein by reference in its entirety.

The magnesium halide salt may be present in a concentration of from 500 ppm to 9000 ppm, preferably from 700 ppm to 1500 ppm. The sodium halide salt may be present in a concentration of from 250 ppm to 4000 ppm, preferably 375 ppm to 2000 ppm. The potassium halide salt may be present in a concentration of up to 4000 ppm i.e. from 1 ppm to 4000 ppm, preferably up to 3000 ppm, more preferably up to 2500 ppm.

Preferably, the magnesium halide, potassium halide and sodium halide salts are chloride salts.

The electrolyte solution formed within the pool may contain from 0 ppm to 300 ppm of a soluble alkali metal halide salt selected from LiBr, NaBr, CaBr₂, MgBr₂ or mixtures thereof. Optionally, the electrolyte solution formed may contain from 0 to 1000 ppm of a soluble zinc halide salt and/or 0 to 1000 ppm of ascorbic acid and/or 0 to 1000 ppm of zinc ascorbate.

It will be appreciated by the skilled person that the present invention is not limited to the embodiments described in detail herein, and that a variety of other embodiments may be contemplated which are, nevertheless, consistent with the broad spirit and scope of the invention.

All computer programs, algorithms, patent and scientific literature referred to in this specification are incorporated herein by reference in their entirety.

1-32. (canceled)

33. A method of sanitising swimming pool water including the steps of:
(a) providing an electrolytic cell having a flow inlet to allow water from the swimming pool to enter the cell, and a flow path having at least one anode and at least one cathode located within the flow path and a flow outlet to allow water exiting the cell to be returned to the swimming pool;
(b) forming a matrix comprising one or more insoluble metal salts adjacent a substantial portion of the at least one anode and/or the at least one cathode;
(c) placing the electrolytic cell comprising the matrix within a flow of water from the swimming pool; and
(d) passing the swimming pool water, via the flow inlet, through the flow path to thereby generate active oxygen species and sanitise the swimming pool water.

34. The method of claim 33 wherein the one or more insoluble metal salts comprise a metal carbonate and/or a metal hydroxide and/or a metal oxide.

35. The method of claim 34 wherein the one or more insoluble metal salts are selected from the group consisting of magnesium carbonate, calcium carbonate, beryllium carbonate, magnesium hydroxide, calcium hydroxide, beryllium hydroxide, magnesium oxide, calcium oxide and beryllium oxide.

36. The method of claim 35 wherein the one or more insoluble metal salts are substantially comprised of calcium carbonate and/or magnesium carbonate.

37. The method of claim 33 wherein the matrix is in direct contact with the at least one anode and/or at least one cathode.

38. The method of claim 33 wherein the active oxygen species comprise a species selected from the group consisting of hydroxyl radicals, oxygen radicals, ozone and peroxide.

39. The method of claim 33 further including the step of introducing oxygen into the swimming pool water prior to its contacting the at least one anode and/or at least one cathode.

40. The method of claim 33 wherein the swimming pool water comprises a magnesium halide salt in a concentration of between 500 ppm to 9000 ppm.

41. The method of claim 40 wherein the swimming pool water further comprises a potassium halide salt in a concentration of up to 4000 ppm.

42. The method of claim 33 wherein the matrix is formed by applying an effective amount of an insoluble metal salt paste to the at least anode and/or at least one cathode or running the electrolytic cell in an optimised water flow remote from the swimming pool.

43. A system for sanitising swimming pool water comprising:
(a) a flow inlet;
(b) a first electrolytic cell having a first flow path adapted to receive water from the flow inlet and at least one anode and at least one cathode located within the first flow path and a first flow path outlet; and
(c) a second electrolytic cell having a second flow path adapted to receive water from the flow inlet or from the first flow path outlet and at least one anode and at least one cathode located within the
wherein the at least one anode and/or at least one cathode of one of the first or the second electrolytic cell has a matrix comprising one or more insoluble metal salts formed adjacent a surface thereof.

44. The system of claim 43 wherein the second electrolytic cell is connected in series with the first electrolytic cell such that the second flow path is in fluid communication with the first flow path and receives water from the first flow path outlet.

45. The system of claim 43 wherein a switch is provided to switch power between the first and second electrolytic cells

46. The system of claim 43 wherein the one or more insoluble metal salts comprise a metal carbonate and/or hydroxide and/or oxide.

47. The system of claim 46 wherein the one or more insoluble metal salts are selected from the group consisting of magnesium carbonate, calcium carbonate, beryllium carbonate, magnesium hydroxide, calcium hydroxide, beryllium hydroxide, magnesium oxide, calcium oxide and beryllium oxide.

48. The system of claim 43 wherein the matrix is in direct contact with the at least one anode and/or the at least one cathode.

49. The system of claim 43 wherein the electrolytic cell which does not have the matrix operates as an electrolytic chlorinator cell predominantly producing chlorine as a sanitiser.

50. The system of claim 43 wherein the electrolytic cell having the matrix operates as a sanitiser predominantly producing active oxygen species.

51. The system of claim 43 further comprising an analysing means to monitor the level of chlorine in the water.

52. The system of claim 51 wherein the analysing means actuates the switch to divert the power to the electrolytic cell predominantly producing chlorine when chlorine levels are low and to the electrolytic cell predominantly producing active oxygen species when chlorine levels are optimal.

53. The system of claim 43 further comprising an oxygen inlet to allow oxygen to be introduced into the flow inlet or the first and/or second flow path.

54. A method of sanitising swimming pool water including the steps of:
(a) providing a water flow inlet;
(b) providing a first electrolytic cell having a first flow path adapted to receive water from the flow inlet and at least one anode and at least one cathode located within the first flow path and a first flow path outlet;
(c) providing a second electrolytic cell having a second flow path adapted to receive water from the flow inlet or the first flow path outlet and at least one anode and at least one cathode located within the second flow path;
(d) forming a matrix comprising one or more insoluble metal salts adjacent the at least one anode and/or at least one cathode of the second electrolytic cell; and
(e) passing a flow of water through the water flow inlet;
whereby, activation of the first electrolytic cell causes the production of active chlorine and activation of the second electrolytic cell causes the production of active oxygen species.
